(19) United States
(12) Patent Application Publication
(10) Pub. No.: US 2014/0244076 A1
(43) Pub. Date: Aug. 28, 2014

(54) STABILITY BASED TAXIING AND TURNING METHOD FOR AIRCRAFT WITH ELECTRIC TAXI SYSTEM

(71) Applicant: HONEYWELL INTERNATIONAL, INC., PATENT SERVICES M/S AB/2B, (US)

(72) Inventors: MUTHUKUMAR MURTHY, VELLORE (IN); MADASAMY SHUNMUGAVEL, BANGALORE (IN); BALAKRISHNA PEDDINENI, INDIA (IN); ROCCO DIVITO, TORONTO (CA)

(73) Assignee: HONEYWELL INTERNATIONAL, INC., PATENT SERVICES M/S AB/2B, Morristown, NJ (US)

(21) Appl. No.: 13/781,659

(22) Filed: Feb. 28, 2013

(51) Int. Cl. B64C 19/00

(52) U.S. Cl. CPC B64C 19/00
USPC 701/3

(57) ABSTRACT

Landing gear apparatus for an aircraft may include a steerable nosewheel assembly and left main landing gear wheels and right main landing gear wheels driven by motors. A controller may receive an angular position of the nosegear wheel assembly. The controller may respond to the angular position by transmitting wheel speed signals to one or more of the motors to maintain the center of gravity of the aircraft within a predetermined stability triangle and to perform short radii turning.

### BACKGROUND OF THE INVENTION

The present invention generally relates to aircraft landing gear and more particularly to landing gear with motor driven propulsion systems.

In aerospace applications, during nosewheel controlled taxi operations, aircraft turning radius may have practical limits according to the body/structure of aircraft. For example, in some cases, the upper limit of steering angle is approximately +/−60 degrees. For larger aircraft, conventional nosewheel-based steering alone may be insufficient to perform short-radius turning thereby requiring main landing gear steering systems. Even with main landing gear steering systems, sharp or tight turns may be performed at low taxi speeds in order to reduce centripetal forces. An aircraft may be at risk of overturning if a lateral component of such forces becomes excessive.

Steering controllability may be further complicated by nosewheel loading and possible shifts of aircraft center of gravity. Two factors affecting aircraft taxiing stability during taxiing are centripetal forces and cross-wind forces. Typically, aircraft taxiing speeds are subject to predetermined safety limits to keep the effect of these forces from causing overturning of the aircraft. Thus average taxiing durations are relatively lengthy, thereby negatively impacting fuel burn and overall ground operations.

As can be seen, there is a need for an aircraft taxi system that may safely accommodate faster taxiing speeds and short radius turning. Additionally there is a need for such a taxi system which allows for short radius turning of an aircraft with reduced risk of overturning

### SUMMARY OF THE INVENTION

In one aspect of the present invention an aircraft may comprise: a steerable nosewheel assembly; main landing gear wheels driven by motors; and a controller (a) to receive angular position of the nosewheel assembly and (b) responsive to the angular position of the nosewheel assembly to transmit wheel speed signals to the motors to maintain a center of gravity of the aircraft within a stability triangle.

In another aspect of the present invention, a controller for an aircraft electric taxi system may comprise: an input receiving nosewheel angle signals; at least one output transmitting speed signals to set main landing gear wheel speeds; wherein the controller varies the main landing gear wheel speed commands responsively to the nosewheel angle signals.

In still another aspect of the invention a method for taxiing an aircraft may comprise the steps of: driving a first main-landing gear wheel with a first variable speed motor; driving a second main-landing gear wheel with a second variable speed motor; producing pilot-selected steering commands by varying angular orientation of a nosewheel assembly relative to a longitudinal axis of the aircraft; responding to the angular orientation of the nosewheel assembly by controlling the speed of the first main-landing gear wheel relative to the speed of the second main-landing gear wheel; calculating centripetal force acting on the aircraft when the angular orientation of the nosewheel assembly is not aligned with the axis of the aircraft; determining if a center of gravity (cg) of the aircraft may be shifted out of a stability triangle of the aircraft as a result of the calculated centripetal force; and producing signals to diminish rotational speed of the main-landing gear wheels responsively to a determination that the center of gravity (cg) of the aircraft may be shifted out of a stability triangle as a result of the calculated centripetal force.

These and other features, aspects and advantages of the present invention will become better understood with reference to the following drawings, description and claims.

### BRIEF DESCRIPTION OF THE DRAWINGS

FIG. 1 is schematic block diagram of an aircraft electric taxi system (ETS) in accordance with an embodiment of the invention;

FIG. 2 is a plan view of an aircraft in which the ETS of figure may have utility in accordance with an embodiment of the invention;

FIG. 3 is a plan view of an aircraft illustrating operational features of the ETS of FIG. 1 in accordance with an embodiment of the invention;

FIG. 4 is schematic diagram of taxing paths that may be followed by the aircraft of FIGS. 2 and 3 in accordance with an embodiment of the present invention; and

FIG. 5 is a flowchart of a method for taxiing an aircraft in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide systems for taxiing an aircraft using a combination of nosewheel steering and main landing gear wheel driving control. More particularly, turn radius and taxiing speed may be coordinated and controlled so that aircraft stability may maintained. Lateral forces acting on the aircraft may be dynamically assessed during taxiing. Rotational speed of main landing gear wheels may be controlled to assure that such forces do not result in overturning of the aircraft.

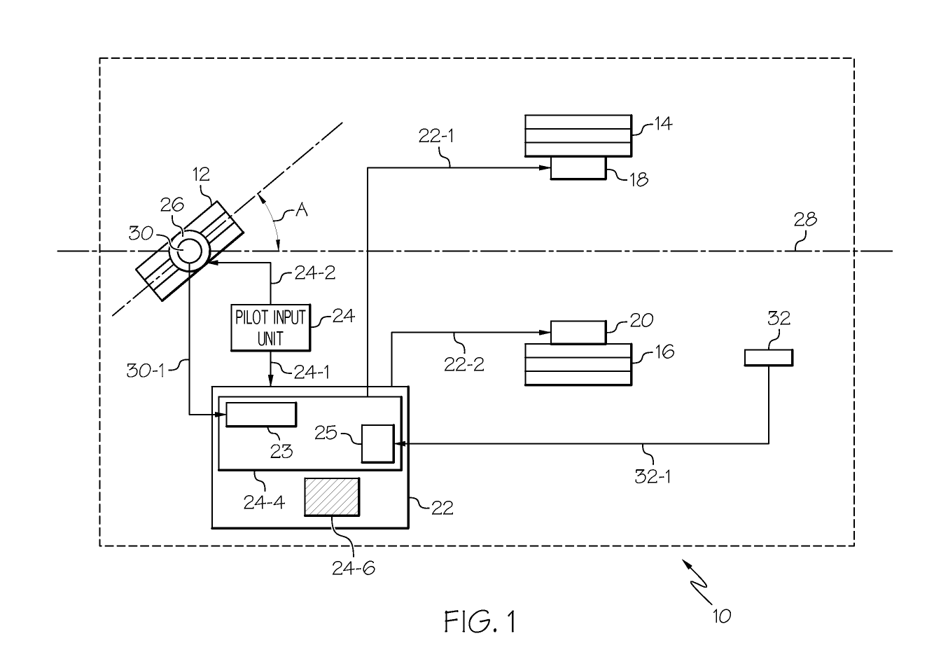

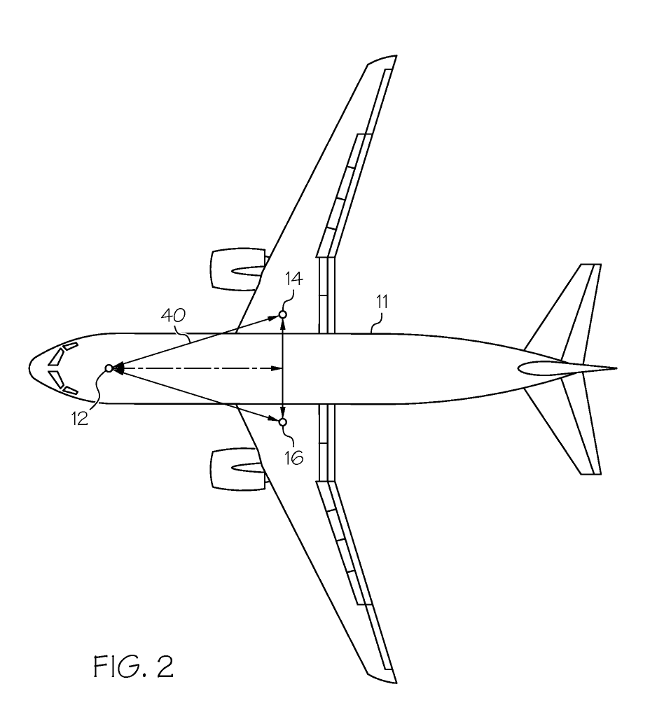

Referring now to FIG. 1, it may be seen that an exemplary taxi system (ETS) 10 of an aircraft 11 (See FIG. 2) may include a nosewheel assembly 12, and main landing gear wheels or wheel sets 14 and 16 (hereinafter wheels 14 and 16). The wheels 14 and 16 may be driven by motors 18 and 20 respectively. The motors 18 and 20 may be supplied with electric power that may originate from a conventional auxiliary power unit (APU) of the aircraft 11.

In operation, the ETS 10 may be controlled by a pilot of the aircraft 11 with various input devices through which the pilot may select speed and direction of movement of the aircraft 11. Collectively these input devices may be referred to as a pilot-input unit 24.

Through operation of the pilot-input unit 24, the aircraft 11 may be commanded to move forward or backward at a speed selected by the pilot. The speed or ground velocity of the aircraft selected by the pilot may be referred to as a base-taxi speed (hereinafter velocity Vb). After the pilot has selected or changed a velocity Vb, a corresponding Vb signal 24-1 may be transmitted from the pilot input unit 24 to the controller 22. The controller 22 may then provide motor speed signals 22-1 and 22-2 to the motors 18 and 20 respectively. In the case of straight-line taxiing, the motors 18 and 20 may be commanded to rotate at equal speeds and at a rate that may propel the aircraft at the selected velocity Vb.

The pilot may also select a change in direction of movement by initiating a turn command through the pilot input unit 24. In that case, a turn signal 24-2 may be transmitted by the pilot input unit 24 to a steering actuator 26 which may produce a change in angular orientation of the nosewheel assembly 12 relative to a longitudinal axis 28 of the aircraft 11. The nosewheel assembly 12 may include an angle sensor 30. The angle sensor 30 may provide a steering angle signal 30-1 indicating the sensed steering angle to the controller 22. As will be explained hereinafter, a change in the steering angle signal 30-1 may result in a change in the motor speed signals 22-1 and 22-2.

Referring now to FIG. 2, a stability triangle 40 is shown superimposed on an image of the aircraft 11. The stability triangle for a typical aircraft may include a plane bounded by lines that approximately interconnect the nosewheel assembly 12 and the main landing gear assemblies 14 and 16. It is a well known aircraft design principle that if a center of gravity (hereinafter cg) on an aircraft remains within its stability triangle 40, then the aircraft may remain stable. In the context of ground-based operations, over steering of the aircraft 11 may result in shift of the cg outside of its stability triangle 40 and may result in overturning of the aircraft 11. Displacement of cg of the aircraft 11 may result from various external forces acting on the aircraft 11. For example, forces from centripetal acceleration during a turn may cause a shift in cg. Also cross winds may apply force to the aircraft sufficient to cause a shift in location of its cg. A shift in cg is may be directly proportional to a sum of a differential in centripetal force and a differential in cross wind force during turning.

Some aircraft may be equipped with a flight management system (FMS) which may have a capability for performing dynamic cg position calculation. Dynamic cg position data from such an FMS may be used to compute a shift in cg resulting from turn-induced centripetal force or cross-wind force. Appropriate wheel speed adjustment may be made to assure that that the aircraft cg remains within the stability triangle.

In an aircraft that is not equipped with an FMS that has the above described capability, one of the controllers 22 may be installed in the aircraft. The controller 22 may determine cg shift in accordance with the conventional expression

Δcg=Δf*L/Wt equation 1

Where:

f=centripetal force+crosswind force;

Wt=weight of the aircraft; and

L=arm length (defined as distance between a relevant part of an aircraft and a datum line)

Referring back now to FIG. 1, it may be noted that the motor speed signal 22-1 and 22-2 may be varied responsively to the nosewheel angle signal 30-1 and a wind load signal 32-1 that may be transmitted to the controller 22 from a wind load sensor 32. The wind load sensor 32 may determine wind speed and direction relative to the axis 28 of the aircraft 11. The signal 32-1 may include the wind speed and direction information. The controller 22 may include memory 24-4 having a centripetal force calculator block 23 and a cross-wind force calculator block 25. The centripetal force calculator block 25 may have instruction in a memory 24-4 that when executed by a processor 24-6 calculates centripetal force acting on the aircraft 11. The cross-wind force calculator block 23 may have instruction that when executed by the processor 24-4 calculates cross-wind force acting on the aircraft. The controller 22 may combine calculated results from the blocks 23 and 25 to determine magnitudes of cg shifts during any turning activity of the aircraft 11.

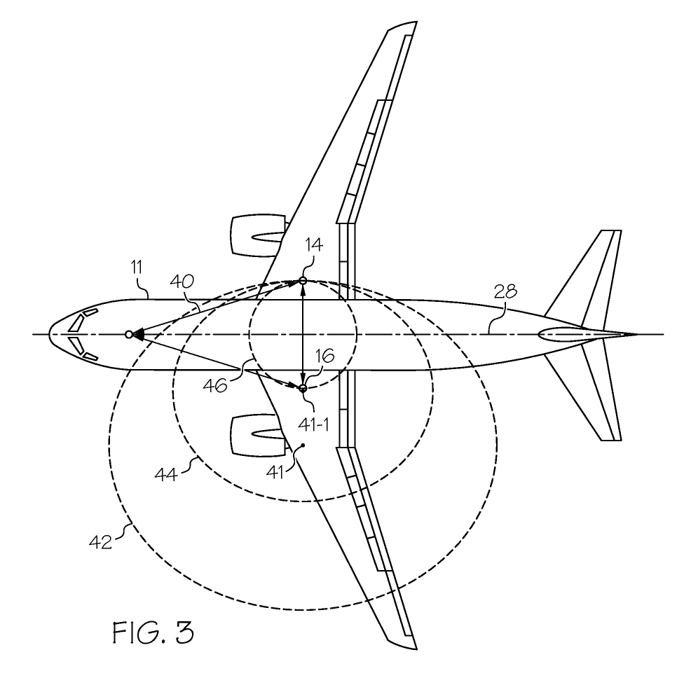

Referring now to FIG. 3 along with FIG. 1, the controller 22 may generate signals that indicate to the motors 18 and 20 to vary relative speeds of the wheels 14 and 16 as a function of an angle A of the nosewheel assembly 12 relative to the axis 28 of the aircraft 11. For example, if the angle A is less than 60°, in a left hand turn, then the speeds of the wheels 14 and 16 may remain equal. If the angle A is between about 60° and 70°, in a left hand turn, then speed of the wheel 16 may be reduced below speed of the wheel 14, This speed differential may result in a movement of a center of rotation 41 to a position 41-1 at the wheel 16. (See FIG. 3). In other words, a radius of turning for a turning arc 44 may be reduced from a radius of turning for a turning arc 42 that would otherwise be followed if only nosewheel steering were employed to steer the aircraft 11.

If the angle A is greater than 70°, in a left hand turn, then the wheel 16 may be commanded to rotate in a direction opposite to that of the wheel 14. In that case, the center of rotation may be moved directly onto the axis 28 of the aircraft 11 and the radius of turning for a turning arc 46 may be reduced to a distance between the axis 28 and location of the wheel 14 or 16.

It should be noted that the particular commands and nosewheel angles discussed above are merely exemplary. For a particular aircraft the relationship wheel speed commands and nosewheel angles may differ from those described above. As illustrated in FIG. 3, the arc 42 may be followed by the nosewheel assembly 12 during a turn in which the wheels 14 and 16 rotate at substantially equal speed. The arc 44 may be followed by the wheel 14 around a pivot point at the wheel 16 during a turn in which the wheel 14 rotates at a speed higher than the speed of the wheel 16. The arc 46 may be followed by the wheels 14 and 16 around a pivot point on the axis 28 of the aircraft 11 when the wheels 14 and 16 rotate in opposite directions. It can be seen that the arcs 44 and 46 have smaller radii than the arc 42.

Smaller radii of turning are advantageous because increased maneuverability may be attained during taxiing. Additionally, a turn may be achieved with a reduced amount of centripetal force when performed at a lower radius of turning. Centripetal force may be determined by the calculator block 23 in accordance with the expression

F_{c}=mv²/r equation 2

Where:

m is mass of the aircraft;

v is the velocity of the aircraft wheel along the arc of turning; and

r is the turning radius.

It can be seen that, for a right angle turn using nosewheel-only steering, the wheel 14 would travel around ¼ of the arc 42. Assuming that the radius of the arc 42 is about 15 meters and the time for performing the turn is 15 seconds then the centripetal force resulting from the nosewheel-only turn would be:

F_{c [nosewheel-only]}={mass of aircraft*[¼ arc length/time for turn]²/radius of turn

F_{c [nosewheel-only]}={m.[(π*15 meters*2/4)/15 sec]²}/15 meters

F_{c [nosewheel-only]}=m*0.164 equation 3

If the same right angle turn were performed using differential- speed rotation of the wheels 14 and 16, then the wheel 14 would follow the arc 44. Assuming that the distance between the wheels 14 and 16 is 5 meters, then the centripetal force resulting from differential-speed turn would be

F_{c[differential-speed]}={m*[(π*5 m.*2/4)/15 sec]²}/5m.

or

F_{c[differential-speed]}=m*0.054 equation. 4

In other words the centripetal force for the differential-speed turn is about ⅓ of the centripetal force of the nosewheel-only turn. Or put another way, the differential-speed turn may be safely executed in less time than the nosewheel-only turn while producing only an equivalent amount of centripetal force. For example, given that centripetal force of 0.164*m is a tolerable amount of force then the differential-speed turn may be made in a time given by the expression:

T²=m*(*r*1/2)²/(r*F_{c[differential-speed])}

T=[(π*r*1/2)²/(r*F_{c[differential-speed]})]^{0.5} equation 5

thus for r=5 meters, T=7.1 seconds

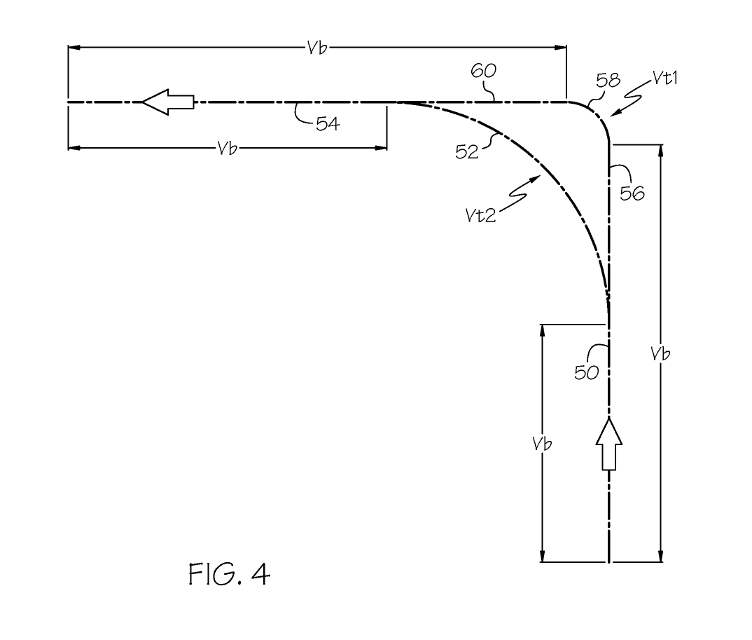

Referring now to FIG. 4, various possible taxi paths are illustrated. For example, the aircraft 11 might follow a path that includes a straight line 50, an arc 52 and a straight line 54. A pilot of the aircraft 11 may select a base velocity Vb for traveling along the lines 50 and 54. The controller 22 may command the wheels 14 and 16 to rotate at equal speeds during the straight line travel. Upon reaching an intersection of the straight line 50 and the arc 52, the pilot may command the nosewheel 12 to turn at an angle less than 60°. The aircraft 11 may then begin to travel on a path around the arc 52. The controller 22 may perform calculations based on the radius of the turn, cross-wind loads and the velocity Vb of the aircraft 11. The controller 22 may determine if centripetal force generated by travel on the arc 52, when added to cross-wind loading, may result in displacement of the cg outside of the stability triangle 40. If the calculated displacement of cg is within safe limits, the controller 22 may command the wheels 14 and 16 to continue propelling the aircraft 11 at the pilot-selected velocity Vb. However if, in response to the calculated cg displacement is beyond a safe limit (i.e., outside of the triangle 40), then the controller 22 may automatically command the wheels 14 and 16 to reduce speed so that centripetal force on the aircraft is reduced as it travels along the arc 52 at a velocity Vt2 so that the calculated cg position is within safe limits.

Alternatively, the pilot may elect to command the aircraft 11 to travel along a straight line 56 and then along an arc 58 before proceeding along a straight line 54. This may be achieved by causing the angle A of the nosewheel 12 to be between about 60° and 70°. Such a maneuver may be advantageous in a high cross-wind situation which may require the controller 22 to slow the aircraft 11 from its Vb velocity during a turn. In following the arc 58, as compared to the arc 52, the aircraft 11 may have more time to travel along straight lines 56 and 60 at the Vb speed and would also be subject to a lower centripetal force during its turn. In that case the controller 22 may permit the aircraft to travel along the arc 58 at a velocity Vt1 which may greater that Vt2.

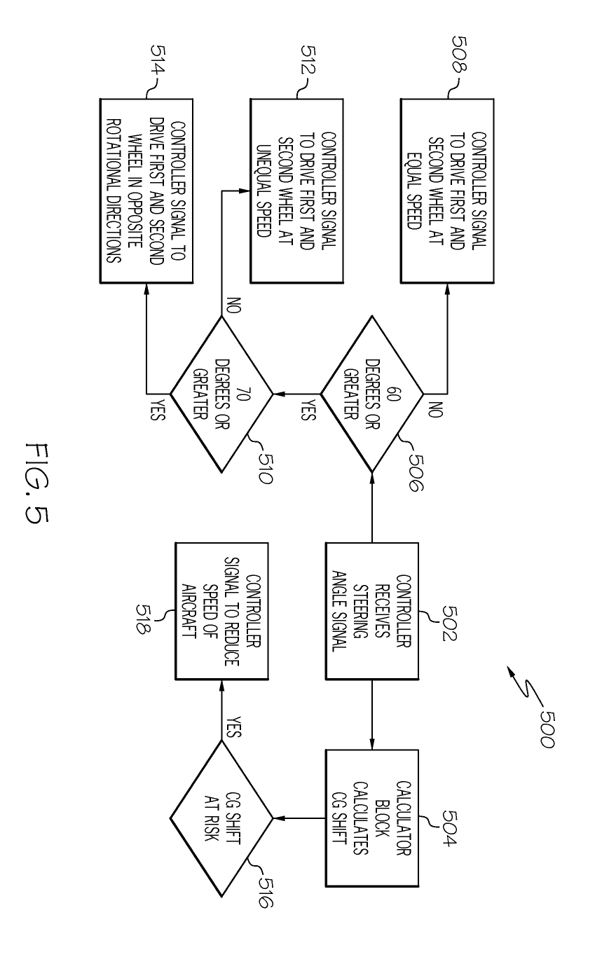

Referring now to FIG. 5, a flowchart 500 may illustrate a method for taxiing an aircraft. In a step 502, the controller 22 receives a signal 24-1 in response to a pilot of an aircraft varying an angular orientation of a nosewheel assembly relative to a longitudinal axis of the aircraft. (e.g., the pilot may employ the pilot input unit 24 to vary the angle of the nosewheel assembly 12 relative to the axis 28 of the aircraft 11). In a step 504, a center of gravity shift may be calculated (e.g., The controller 22, using calculator block 23, may calculate centripetal force that may develop when the aircraft 11 travels an arc determined by the angular orientation of the nosewheel assembly 12.) Additionally, the controller 22 using the cross-wind calculator block 25 may calculate cross-wind force based on an input signal 32-1 from the cross-wind sensor 32. The cg shift may be calculated by the controller 22 based on calculated results using the calculator blocks 23 and 25 in accordance with equation 1.

In a step 506, a determination may be made by controller as to whether the nosewheel assembly angle is greater than a predetermined amount, e.g. 60°. If the angle is less than 60°, then a step 508 may be implemented in which the wheels 14 and 16 may be driven at equal speeds. If the angle is 60° or greater, then a step 510 may be implemented in which a determination may be made as to whether the angle is a second predetermined amount, e.g. 70° or greater. If the angle is less than 70° but more than 60°, then a step 512 may be implemented in which the wheels 14 and 16 may be driven at different speeds, thereby achieving the effect of propelling the aircraft 11 along an arc that has a center of rotation located at one of the wheels 14 or 16. If the angle is greater than 70°, then a step 514 may be implemented in which the wheels 14 and 16 may be driven in opposite rotational directions thereby achieving turning of the aircraft about a point on the axis 28 of the aircraft.

Throughout the operation of any of the steps 508, 512 or 514, the step 504 may be continuously performed. Additionally, a comparison step 516 may be continuously performed by the controller in which a determination may be made as to whether a calculated cg shift may result is a displacement of the cg outside of the stability triangle 40 of the aircraft. In the event that such a displacement of cg outside of the stability triangle 40 is determined to be probable, then in step 518 the controller may determine a reduced speed of the aircraft 11 and send a signal to the motors 18 and 20 to reduce the speed of the aircraft that centripetal force on the aircraft 11 is reduced. In other words, if there is determination that the probability of cg displacement outside of the stability triangle may exceed a predetermined probability (e.g. a probability higher than about 80%), then speed of the aircraft may be reduced.

By employing the method described above, an aircraft may be safely taxied at speeds higher than those typically used in prior art taxiing systems. Moreover, the apparatus and methods described above are particularly advantageous when an aircraft is taxied in a reverse direction. Reverse taxiing is inherently more risky than forward direction taxiing. Indeed, reverse movement of an aircraft is most often performed with a tow vehicle pushing the aircraft. Self-propelled reverse taxiing is typically avoided entirely because of a high risk of aircraft damage resulting from nose up condition. The presently described methods and apparatus may be employed to safely perform self-propelled reverse taxiing of an aircraft.

It should be understood, of course, that the foregoing relates to exemplary embodiments of the invention and that modifications may be made without departing from the spirit and scope of the invention as set forth in the following claims.

We claim:

1. An aircraft comprising:
a steerable nosewheel assembly;
main landing gear wheels driven by motors; and
a controller (a) to receive angular position of the nosewheel assembly and (b) responsive to the angular position of the nosewheel assembly to transmit wheel speed signals to the motors to maintain a center of gravity of the aircraft within a stability triangle.

2. The apparatus of claim 1 wherein the controller includes a cross-wind force calculator block having instruction that when executed by a processor calculates cross-wind force acting on the aircraft; and wherein the controller transmits wheel speed signals to the motors responsively to said calculated cross-wind force.

3. The apparatus of claim 2 further comprising a wind load sensor and wherein the cross-wind force calculator block is connected to respond to said wind load sensor.

4. The apparatus of claim 1 wherein the controller includes a centripetal force calculator block having instruction that when executed by a processor calculates centripetal force acting on the aircraft; and wherein the controller transmits wheel speed signals to the motors responsively to said calculated centripetal force.

5. The apparatus of claim 4 further comprising a nosewheel angle sensor and wherein the centripetal force calculator block is connected to respond to the nosewheel angle sensor.

6. The apparatus of claim 1:
wherein the controller includes a cross-wind force calculator block having instruction that when executed by a processor calculates cross-wind force acting on the aircraft;
wherein the controller includes a cross-wind force calculator block having instruction that when executed by a processor calculates cross-wind force acting on the aircraft; and
wherein the controller transmits wheel speed signals to the motors in response to a combined calculated cross-wind force and calculated centripetal force acting on the aircraft.

7. A controller for an aircraft taxi system comprising:
an input receiving nosewheel angle signals;
at least one output transmitting speed signals to set main landing gear wheel speeds;.
wherein the controller varies the main landing gear wheel speed commands responsively to the nosewheel angle signals.

8. The controller of claim 7 further comprising:
an input receiving aircraft pilot controlled base-speed commands;
a calculator block to calculate centripetal force that develops when the aircraft travels an arc determined in accordance with the nosewheel angle data.
wherein the controller varies the wheel speed commands responsively to the calculated centripetal force and the base-speed commands.

9. The controller of claim 8 further comprising:
an input receiving wind speed and direction data; and
a cross-wind force calculator calculating cross-wind force on the aircraft;
wherein the controller varies the wheel speed commands responsively to the calculated centripetal force and the calculated cross-wind force.

10. The controller of claim 7 further comprising:
an input receiving aircraft pilot controlled base-speed commands;
an input receiving cross-wind load data; and
a cross-wind force calculator calculating cross-wind force on the aircraft;
wherein the controller varies the wheel speed commands responsively to the nosewheel angle data, the calculated cross-wind force and the base-speed commands.

11. The controller of claim 7 comprising:
at least two outputs transmitting wheel speed commands,
wherein, upon receiving nosewheel angle data indicating a first predetermined nosewheel angle of, a first one of the at least two outputs transmits a first speed command to a first wheel motor and a second one of the at least two outputs transmits a second speed command to a second wheel motor so that differential speed between the first and second motors results in turning of the aircraft.

12. The controller of claim 11 wherein the first predetermined angle is between about 60° and 70°.

13. The controller of claim 7 comprising:
at least two outputs transmitting wheel speed commands,
wherein, upon receiving a second predetermined nosewheel angle data, a first one of the at least two outputs transmits a first speed command to a first wheel motor for rotation in a first direction and a second one of the at least two outputs transmits a second speed command to a second wheel motor for rotation in a direction opposite to the first direction so that differential speed between the first and second motors results in turning of about a point on a longitudinal axis of the aircraft.

14. The controller of claim 13 wherein the second predetermined angle is about 70 or greater.

15. A method for taxiing an aircraft comprising the steps of:
driving a first main-landing gear wheel with a first variable speed motor;
driving a second main-landing gear wheel with a second variable speed motor;
producing pilot-selected steering commands by varying angular orientation of a nosewheel assembly relative to a longitudinal axis of the aircraft;
responding to the angular orientation of the nosewheel assembly by controlling the speed of the first main-landing gear wheel relative to the speed of the second main-landing gear wheel;
calculating centripetal force acting on the aircraft when the angular orientation of the nosewheel assembly is not aligned with the axis of the aircraft;
determining if a center of gravity (cg) of the aircraft may be shifted out of a stability triangle of the aircraft as a result of the calculated centripetal force;
producing signals to modify rotational speed of the main-landing gear wheels responsively to a determination that the center of gravity (cg) of the aircraft may be shifted out of a stability triangle as a result of the calculated centripetal force.

16. The method of claim 15 wherein the speed of the first main-landing gear wheel relative to the speed of the second main-landing gear wheel is varied only when the angular orientation of the nosewheel assembly relative to the axis is about 60° or greater.

17. The method of claim 15 wherein the first main-landing gear wheel is rotated in a first rotational direction and the second main-landing gear wheel is rotated in a second rotational direction opposite the first rotational direction when the angular orientation of the nosewheel assembly relative to the axis is about 70° or greater.

18. The method of claim 15 wherein the step of calculating centripetal force includes determining a radius of turning of the aircraft.

19. The method of claim 15 further comprising the steps of:
calculating cross-wind force acting on the aircraft when the angular orientation of the nosewheel assembly is not aligned with the axis of the aircraft;
determining if a center of gravity (cg) of the aircraft is at risk of being shifted out of a stability triangle of the aircraft as a result of the calculated cross-wind force;
producing signals to diminish rotational speed of the main-landing gear wheels responsively to a determination that the center of gravity (cg) of the aircraft is at risk of being shifted out of a stability triangle as a result of the calculated cross-wind force.

20. The method of claim 15 further comprising the steps of:
calculating centripetal force and cross-wind force acting on the aircraft when the angular orientation of the nosewheel assembly is not aligned with the axis of the aircraft;
determining if a center of gravity (cg) of the aircraft is at risk of being shifted out of a stability triangle of the aircraft as a result of the calculated centripetal force and cross-wind force;
producing signals to diminish rotational speed of the main-landing gear wheels responsively to a determination that the center of gravity (cg) of the aircraft may be shifted out of the stability triangle as a result of the calculated centripetal force and cross-wind force.
